(19) United States
(12) Patent Application Publication
(10) Pub. No.: US 2025/0095336 A1
(43) Pub. Date: Mar. 20, 2025

(54) METHOD AND DEVICE FOR DETECTING OBJECTS THROUGH IMAGE PYRAMID SYNTHESIS OF HETEROGENEOUS RESOLUTION IMAGES

(71) Applicant: POSTECH RESEARCH AND BUSINESS DEVELOPMENT FOUNDATION, Pohang-si (KR)

(72) Inventors: Dai Jin KIM, Pohang-si (KR); Tae Hun KIM, Pohang-si (KR)

(73) Assignee: POSTECH RESEARCH AND BUSINESS DEVELOPMENT FOUNDATION, Pohang-si (KR)

(21) Appl. No.: 18/888,977

(22) Filed: Sep. 18, 2024

(30) Foreign Application Priority Data
Sep. 19, 2023 (KR) 10-2023-0124890
Feb. 13, 2024 (KR) 10-2024-0020605

(51) Int. Cl. G06V 10/77; G06T 3/40; G06V 10/82

(52) U.S. Cl. CPC G06V 10/7715; G06T 3/40; G06V 10/82

(57) ABSTRACT

An object detection device is provided. The object detection device may include an input device for receiving an input image, an object detection model for generating a plurality of input images of different resolutions using the input image, a processor for acquiring a plurality of pyramid images of different resolutions using the plurality of input images, an important object image representing a preset important object in the input image based on the plurality of pyramid images, and an output device for outputting the important object image. A method is also disclosed.

### CROSS-REFERENCE TO RELATED APPLICATIONS

This application claims priority to and the benefit of Korean Patent Application No. 10-2023-0124890 filed in the Korean Intellectual Property Office on Sep. 19, 2023, and Korean Patent Application No. 10-2024-0020605 filed in the Korean Intellectual Property Office on Feb. 13, 2024. The entire contents of the foregoing applications are incorporated herein by reference for all purposes.

### BACKGROUND

### (a) Technical Field

The present disclosure relates to a method and device for detecting an important object in an image. More particularly, it relates to a method and device for precisely detecting an important object through image pyramid synthesis of images with heterogeneous resolutions.

### (b) Description of the Related Art

Salient object detection is the pixel-by-pixel detection of the most salient objects in an input image. Salient object detection is utilized in many computer vision applications and is a key enabler for unsupervised learning techniques, especially those with limited training data. Recently, there has been a growing demand for high-precision salient object detection in high-definition images.

According to the prior art, when a model trained with a low-quality dataset is used for detecting an important object, the detection result is derived by reducing the resolution of the input image to the low resolution used for training, so that the high-frequency components of the image are lost during the sampling process, and it is difficult to expect a high-precision detection result. In addition, in the case of an important object detection network trained with a low-resolution based on the prior art, when a high-resolution image is input, it is difficult to expect a normal detection result due to the difference in the receptive field of the important object detection network. On the other hand, if a model trained on a high-definition dataset is used to detect important objects, acquiring a high-definition dataset requires a complex network design to improve performance, which unnecessarily incurs additional costs.

The description of the related art should not be assumed to be prior art merely because it is mentioned in or associated with this section. The description of the related art includes information that describes one or more aspects of the subject technology, and the description in this section does not limit the invention.

### SUMMARY

One or more aspects of the present disclosure aim to provide a method for detecting an object through image pyramid synthesis of heterogeneous resolution images, and an device for the same, to detect an important object more precisely than important object detection techniques according to the prior art.

An object detection device according to one or more aspects of the present disclosure may include: an input device for receiving an input image; an object detection model for generating a plurality of input images of different resolutions using the input image, and obtaining a plurality of pyramid images of different resolutions using the plurality of input images; a processor for obtaining an important object image representative of a predetermined important object in the input image based on the plurality of pyramid images; and an output device for outputting the important object image.

The object detection model may comprise a backbone network comprising a plurality of layers outputting feature maps from which semantic information is extracted from the input image, characterized in that a plurality of first feature maps having a smaller size among the feature maps output through the backbone network are used to generate the highest resolution pyramid image, and a plurality of second feature maps having a larger size among the feature maps output through the backbone network are used to generate the remaining pyramid images.

The object detection model may be characterized by generating a low resolution input image and a high resolution input image, and obtaining a plurality of low resolution pyramid images and a plurality of high resolution pyramid images using the low resolution input image and the high resolution input image.

The processor may be characterized in that the plurality of low resolution important object images are generated using the plurality of low resolution pyramid images, the plurality of high resolution important object images are generated using the plurality of high resolution pyramid images, and the plurality of low resolution important object images and the plurality of high resolution important object images are composited to obtain a final important object image.

The processor may be characterized in that the plurality of low resolution important object images and the plurality of high resolution important object images are used to generate a plurality of peripheral area images representative of an area surrounding the important object in the input image, and the plurality of peripheral area images, the plurality of low resolution important object images, and the plurality of high resolution important object images are used to generate a final important object image.

A method for detecting an important object in an input image by an object detection device according to one or more aspects of the present disclosure, wherein an object detection model of the object detection device generates a plurality of input images of different resolutions using the input images; wherein the object detection model acquires a plurality of pyramid images of different resolutions using the plurality of input images; wherein a processor of the object detection device obtains, based on the plurality of pyramid images, an important object image representative of a predetermined important object in the input image; and wherein an output device of the object detection device outputs the important object image.

An object detection model may comprise a backbone network including a plurality of layers outputting feature maps with semantic information extracted from the input image, wherein the object detection model generates the highest resolution pyramid image using a plurality of first feature maps having a smaller size among the feature maps output by the backbone network.

The object detection model may be characterized in that the remaining pyramid images are generated using a plurality of second feature maps that are larger in size than the feature maps output by the backbone network.

The object detection model may comprise: generating a low-resolution input image and a high-resolution input image; and obtaining a plurality of low-resolution pyramid images and a plurality of high-resolution pyramid images using the low-resolution input image and the high-resolution input image.

The processor may include configurations: wherein the processor generates a plurality of low-resolution important object images using the plurality of low-resolution pyramid images; wherein the processor generates a plurality of high-resolution important object images using the plurality of high-resolution pyramid images; and wherein the processor synthesizes the plurality of low-resolution important object images and the plurality of high-resolution important object images to obtain a final important object image.

The processor may comprise configurations for: generating, using the plurality of low-resolution important object images and the plurality of high-resolution important object images, a plurality of peripheral area images representative of an area surrounding an important object in the input image; and generating, using the plurality of peripheral area images, the plurality of low-resolution important object images, and the plurality of high-resolution important object images, a final important object image.

One or more aspects of the present disclosure enable image pyramid synthesis of heterogeneous resolution images using a model trained on a low-resolution dataset to detect important objects with greater precision.

The effects to be obtained from the present disclosure are not limited to those mentioned above, and other effects not mentioned will be apparent to one having ordinary skill in the art to which the present invention belongs from the following description.

### BRIEF DESCRIPTION OF THE DRAWINGS

FIG. 1 illustrates an object detection device for detecting an important object according to one or more aspects of the present disclosure.

FIG. 2 illustrates the structure of an encoder network according to one or more aspects of the present disclosure.

FIG. 3 illustrates the structure of an encoder network and a decoder network according to one or more aspects of the present disclosure.

FIG. 4 illustrates the structure of a context network according to one or more aspects of the present disclosure.

FIG. 5 illustrates a process for acquiring a final important object image using multiple important object images of different resolutions in accordance with one or more aspects of the present disclosure.

FIG. 6 is a flow diagram illustrating an object detection method according to one or more aspects of the present disclosure.

### DETAILED DESCRIPTION

The terms used in this specification have been chosen to be as generic as possible in current common usage, taking into account their function in the invention, but they may vary according to the intent, custom, or practice of those skilled in the art or the emergence of new technologies. In addition, in certain cases, the terms have been chosen arbitrarily by the applicant, in which case their meaning will be set forth in the description of the invention. It is therefore intended that the terms used in this specification should be construed in accordance with the actual meaning of the term and the context of the specification as a whole, and not merely as a designation of a term.

Furthermore, the invention described herein is subject to various modifications and may have many embodiments, certain embodiments of which are illustrated in the drawings and further described in the detailed description. However, this is not intended to limit the invention to any particular embodiment, and is to be understood to include all modifications, equivalents, or substitutions that fall within the scope of the thought and skill of the present invention. In the description of the respective drawings, like reference numerals are used for like components.

Terms such as first, second, A, B, and the like may be used to describe various components, but the components shall not be limited by such terms. These terms are used only for the purpose of distinguishing one component from another. For example, a first component may be named a second component, and similarly, a second component may be named a first component, without departing from the scope of the present invention. The terms and/or include any combination of a plurality of related recited items or any one of a plurality of related recited items.

When a component is referred to as being “connected” or “plugged into” another component, it should be understood that it may be directly connected or plugged into that other component, but there may be other components in between. On the other hand, when a component is the to be “directly connected” or “directly connected” to another component, it should be understood that there are no other components in between.

Unless otherwise defined, all terms used herein, including technical or scientific terms, shall have the same meaning as commonly understood by one of ordinary skill in the art to which the present invention belongs. Such terms, as defined in commonly used dictionaries, shall be construed to have a meaning consistent with their meaning in the context of the relevant art and shall not be construed to have an idealized or unduly formal meaning unless expressly defined herein.

Hereinafter, example embodiments of the present disclosure will be described in detail with reference to the accompanying drawings.

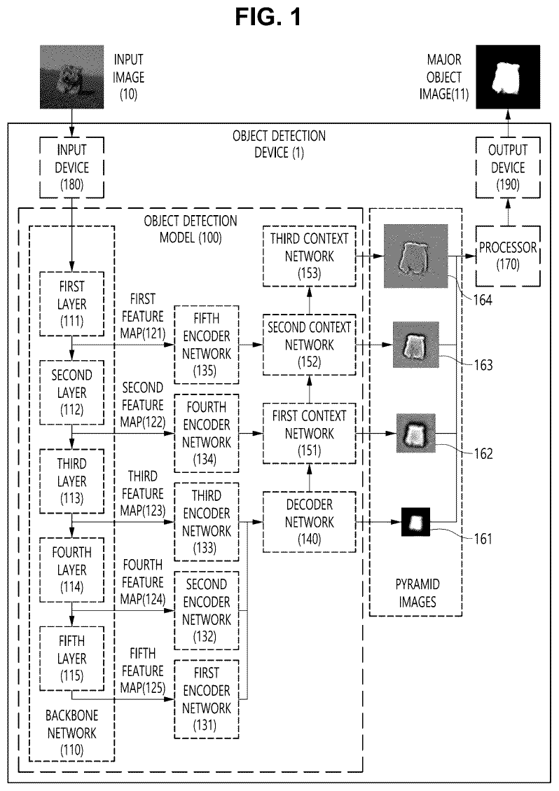

FIG. 1 illustrates an object detection device for detecting an important object according to one or more aspects of the present disclosure.

Referring to FIG. 1, an object detection device 1 may include an input device 180, an output device 190, a processor 170, and an object detection model 100.

First, the object detection device may receive an input image 10 using an input device. The input image may be divided into a background region and an object region. Here, the object region may include an important object that is a target for detection by the object detection device in an embodiment of the present disclosure.

For example, the object detection model 100 may be pre-trained to predict or detect visually important portion(s) within an input image. Further, when a new image is input after the object detection model has been trained, the important object(s) can be detected via one of the two methods described below. For example, as an example of the first salient object detection method, the Fixation Prediction (FP) method predicts where a person's gaze is most likely to be in the image. Second, Salient Object Detection (SOD) detects objects or regions in an image that a person would consider important. The goal of SOD is to better separate the background from important foreground objects. SOD is related to object detection and semantic segmentation, but they have different goals. Object detection aims to find objects in an image, enclose them in a bounding box, and categorize them, while semantic segmentation divides objects in an image into meaningful units. In contrast, SOD aims to detect objects in an image that are considered important. For example, the object detection model 100 may be, but is not necessarily limited to, a detection model based on the Salient Object Detection (SOD) method described above. An important object according to an embodiment of the present disclosure may be, but need not be limited to, an important object output by an object detection model of the SOD method described above.

Referring again to FIG. 1, when the input image 10 is received by the input device 180, the backbone network 110 of the object detection model may generate at least one of the feature maps 121, 122, 123, 124, 125. Here, the backbone network may be, but is not necessarily limited to, a ResNet or SwinTransformer as is well known in the art.

For example, the backbone network may include a first layer 111, a second layer 112, a third layer 113, a fourth layer 114, and a fifth layer 115. However, the backbone network need not necessarily include only five layers, and may include at least one layer for generating at least one feature map.

To increase the computational efficiency of each of the encoder networks 131, 132, 133, 134, 135, the backbone network may reduce the size of the input image. For example, each time the input image passes through one layer, the backbone network may reduce the size of the input image by a preset percentage (e.g., ½). Further, each time the input image passes through one layer, the backbone network may extract a certain percentage of the information about the input image that is semantic. That is, as the input image passes through more layers, the size of the input image becomes smaller, and the percentage of the information about the input image that is semantic becomes larger than the percentage of the other information.

According to one or more aspects of the present disclosure, when the input image passes through the first layer, the backbone network generates a first feature map 121. Then, when the input image passes through the second layer, the backbone network generates a second feature map 122 having a smaller size than the first feature map, and when the input image passes through the third layer, the backbone network generates a third feature map 123 having a smaller size than the second feature map. Further, when the input image passes through the fourth layer, the backbone network generates a fourth feature map 124 having a smaller size than the third feature map, and when the input image passes through the fifth layer, the backbone network generates a fifth feature map 125 having a smaller size than the fourth feature map. In other words, the fifth feature map 125, which has passed through all five layers 111, 112, 113, 114, 115, may be the feature map that has the smallest size among the five feature maps 121, 122, 123, 124, 125, while having the largest ratio of semantic information to other information in the image.

Next, the object detection model inputs the fifth feature map 125 of the smallest size of the five feature maps into the first encoder network 131, the fourth feature map 124 of the second smallest size into the second encoder network 132, the fifth feature map 123 of the third smallest size into the third encoder network 133, the second feature map 122 of the second largest size into the fourth encoder network 134, and the first feature map 122 of the first largest size into the fourth encoder network 135, the third feature map 123 of the third smallest size into the third encoder network 133, the second feature map 122 of the second largest size into the fourth encoder network 134, and the first feature map 121 of the first largest size into the fifth encoder network 135 to encode the input image (feature maps).

For example, each encoder network can be a parallel axis attentional encoder network. A parallel axis attentional encoder network encodes the input image by calculating how each element of the input image is related to the other elements, giving greater weight to important information.

The object detection model may then decode the three smallest feature maps 123, 124, and 125 of the plurality of feature maps that have passed through each encoder using the decoder network 140 to generate the first pyramid image 161 (Initial Saliency Map), which is the highest resolution of the pyramid images (located at the top layer).

The image pyramid technique is one of the methods for dealing with scale in image processing, and is used to segment a given image into different resolutions. Image pyramids are utilized in a variety of applications, including object detection, image scale conversion, and image feature extraction. There are two main types of image pyramids. First, Gaussian Pyramids are utilized to reduce the image size or apply blurring effects. Gaussian pyramids are a technique that decomposes an image into different levels of sub-images. In other words, the Gaussian pyramid technique creates a lower resolution image (the top layer image) and a higher resolution image (the bottom layer image). The Gaussian pyramid technique can be used to extract different frequency components of an image. The lowest level of the Gaussian pyramid is the original image (high resolution), and as you move up the pyramid, there are sub-images (low resolution) from which the high frequency components have been removed. The Gaussian pyramid technique uses a Gaussian smoothing filter to generate the side images. The Gaussian smoothing filter removes the high-frequency components from the original image and emphasizes the low-frequency components. In a Gaussian pyramid, down-sampling is the act of reducing the image resolution by removing pixels that correspond to even and non-odd numbers in the higher resolution image (the lower stage image) to produce a lower resolution image (the upper stage image). In a Gaussian pyramid, up-sampling is the act of adding pixels to the even and uneven terms of the lower-resolution image (upper-level image) to create a higher-resolution image (lower-level image). Second, Laplacian Pyramids are created as a result of Gaussian Pyramids. The lowest level image of the Laplacian Pyramid is generated by subtracting the lower level image of the Gaussian Pyramid from the original image, i.e., the lowest level image of the Laplacian Pyramid is the result of subtracting the lower level image from the original image. Also, the highest level image of the Laplacian Pyramid is generated by adding the higher level image of the Gaussian Pyramid from the original image. Laplacian pyramids can be used to extract details from an image and detect changes. Laplacian pyramids are mainly used in image processing and computer vision, and have a wide range of applications, including image restoration, feature extraction, and scale transformation. It is also used in research such as medical image quality improvement and total variance noise removal using GPUs.

Referring again to FIG. 1, the object detection device may generate the remaining pyramid images 162, 163, 164, other than the first pyramid image, using the plurality of context networks 151, 152, 153. For example, the object detection model may generate the second pyramid image 162 with the second highest resolution by passing the second feature map 122 with the second largest size to the fourth encoder network 134 and inputting the second feature map and the first pyramid image to the first context network 151. The object detection model may then pass the first feature map 121 with the largest size to the fifth in-corner network 135 and input the first feature map and second pyramid image to the second context network 152 to generate a third, higher resolution third pyramid image 163. Then, due to the different sizes of the feature map extracted from the backbone network and the input image, the object detection model can generate a fourth, higher resolution third pyramid image 163 by passing only the third pyramid image 163 output from the second context network 152 to the third context network 153.

Here, the output of each context network may have scale-invariant characteristics, but is not necessarily limited thereto. Here, the remaining pyramid images 162, 163, 164 may be known Laplacian important object detection images.

The processor 170 of the object detection device may then perform a known image pyramid operation on the plurality of pyramid images 161, 162, 163, 164 to reconstruct the important object image 11. Here, the important object image may have the same size as the input image. The important object image may include an important object detection result.

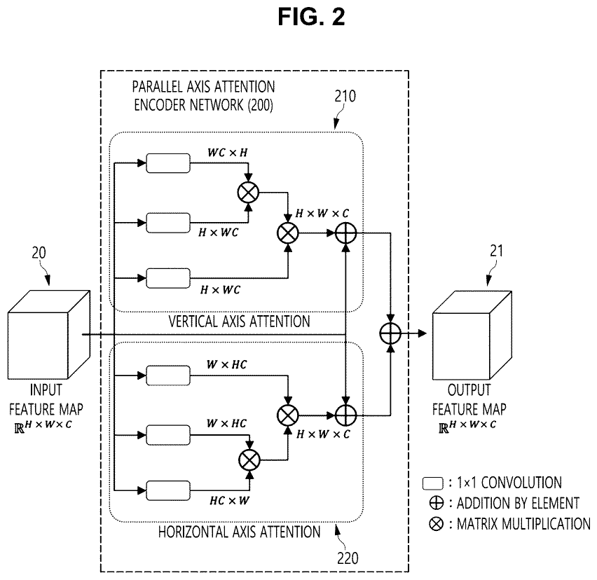

FIG. 2 illustrates the structure of an encoder network according to one or more aspects of the present disclosure.

As shown in FIG. 2, the encoder network can be a parallel axis attendance encoder network 200. Each of the encoder networks 131, 132, 133, 134, 135 of FIG. 1 can be a parallel axis attachment encoder network of FIG. 2.

The parallel axis attentional encoder network 200 may comprise vertical axis attentions 210 and horizontal axis attentions 220. The vertical axis attentions perform operations on vertical axis elements of the elements of the input feature map. The horizontal axis attachment performs operations on the horizontal axis elements of the elements in the input feature map. The vertical and horizontal axis attentions may each include a plurality of 1×1 convolutional operators, elementwise addition operators, and matrix product operators.

In accordance with one or more aspects of the present disclosure, when the input feature map 20 is input, the vertical axis attender applies a 1×1 convolution to convert the sizes of the input feature map to WC×H, H×WC, and H×WC, respectively. The Vertical Axis Attention then performs a matrix product on the feature maps of size WC×H and the feature maps of size H×WC, and performs a matrix product on the result of the matrix product and the feature maps of size H×WC.

When the input feature map is input, the horizontal axis attentions apply a 1×1 convolution to convert the size of the input feature map to W×HC, W×HC, and HC×W, respectively. The Horizontal Axis Attention then performs a matrix product on the feature maps of size HC×W and the feature map of size W×HC, and performs a matrix product on the result of the matrix product and the feature map of size W×HC.

The parallel axis-attention encoder network outputs the output feature map 21 by performing an element-by-element addition crosswise over the final multiplication result by the vertical axis-attention and the final multiplication result by the horizontal axis-attention, and once again performing an element-by-element addition over the result of the element-by-element addition.

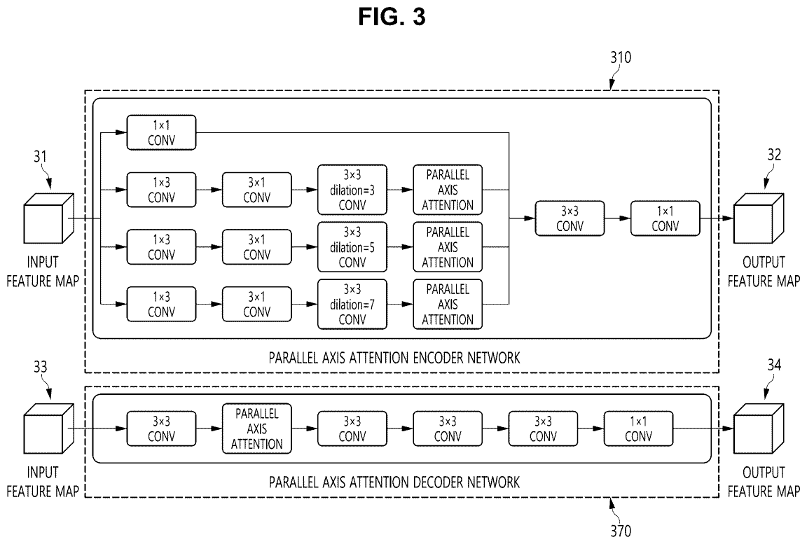

FIG. 3 illustrates the structure of an encoder network and a decoder network according to one or more aspects of the present disclosure.

As shown in FIG. 3, the parallel axis attitude encoder network 310 may include a plurality of 1×1 convolutional operators, a plurality of 1×3 convolutional operators, a plurality of 3×1 convolutional operators, a plurality of 3×3 erosion convolutional operators, and a plurality of parallel axis attitude, 3×3 convolutional operators.

The parallel axis attentional encoder network 310 outputs the output feature map 32 by performing a 1×1 convolutional operation, a 3×1 convolutional operation, a 3×3 erosion convolution (3×3 dilation=3) (3×3 dilation=5) (3×3 dilation=7), a parallel axis attentional operation, a 3×3 convolutional operation, and a lxi convolutional operation on the input feature map 31.

The parallel axis attitude decoder network 370 may include a plurality of 3×3 convolutional operators, parallel axis attitude operators, and 1×1 convolutional operators.

The parallel axis attentional decoder network 370 performs a 3×3 convolutional operation, a parallel axis attentional operation, a plurality of 3×3 convolutional operations, and a 1×1 convolutional operation on the input feature map 33 to output an output feature map 34.

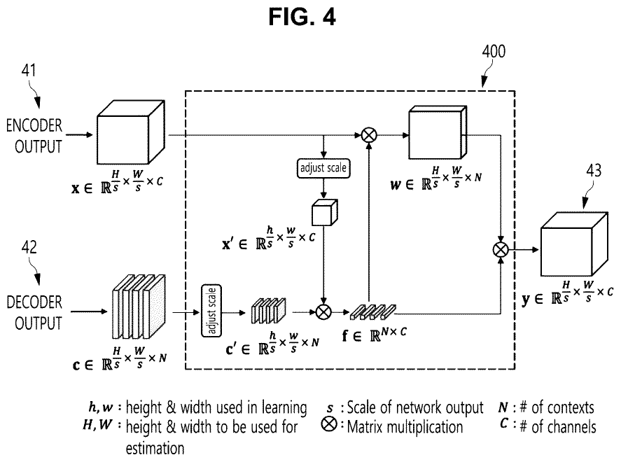

FIG. 4 illustrates the structure of a context network according to one or more aspects of the present disclosure.

The attentional computation described above can be highly variable depending on the size of the input image, which determines the size of the input feature map. To reduce this variability, a scale-invariant context network (the context network in FIG. 1) can utilize input image size information used for training that is not considered in the attentional computation.

The scale-invariant contextual attentional network 400 may derive the output feature map 43 through cross-attention to the contextual information and input feature maps 41, 42 to utilize information from the important object detection results output from the previous layer.

Here, contextual information can be a combination of information about the location of the important object (Foreground Map), background information other than the location of the important object (Background Map), and information about areas of uncertainty that are neither the location of the important object nor the background (Uncertainty Map).

As shown in FIG. 4, when the encoder output 41 is input to the context network, the scale-invariant context network 400 may first reduce the size of the encoder output from H/s×W/s×c to h/s×w/s×c, where H, W is the height of the image to be estimated, h, w is the height of the image used for training, s is the scale of the network's output, and c is the number of channels in the image. Where H, W are the height and width of the image to be used for estimation, h, w are the height and width of the image used for training, s is the output scale of the network, and c is the number of channels in the image.

In addition, when the decoder output 42 is input to the context network, the scale-invariant context network 400 may reduce the size of the decoder output from H/s×W/s×c to h/s×w/s×c.

The scale-invariant context network then performs a first matrix product on the scaled encoder output and decoder output. Furthermore, the scale-invariant context network performs a second matrix product on the scaled encoder output and the result of the first matrix product to generate a feature map of size H/s×W/s×N, where N is the number of contextual information, where N is the number of pieces of contextual information.

Finally, the scale-invariant context network generates a feature map 43 of size H/s×W/s×c by performing a third matrix product on the result of the first matrix product and the result of the second matrix product.

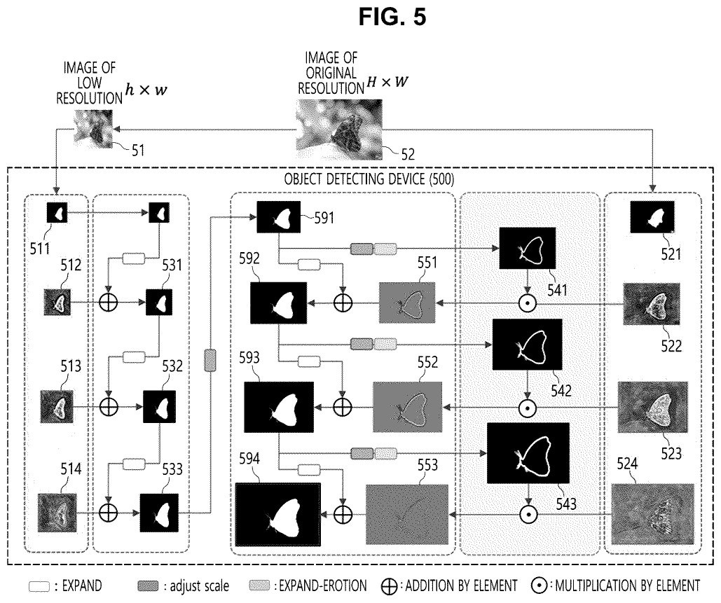

FIG. 5 illustrates a process for acquiring a final important object image using multiple important object images of different resolutions in accordance with one or more aspects of the present disclosure.

As shown in FIG. 5, the object detection device 500 (object detection device 1 of FIG. 1) may extract a low-quality input image (size: H×W) 51 from the input image (input image 10 of FIG. 1) and extract an original input image (size: H×W) 52. Here, the size (h×w) of the low-quality input image may be the size used when training the object detection model (object detection model 100 in FIG. 1).

The object detection device may then input the low-quality input image 51 into the object detection model (object detection model 100 of FIG. 1) to generate a plurality of (e.g., four) low-resolution pyramid images 511, 512, 513, 514. Further, the object detection device may generate a plurality of (e.g., four) high-resolution pyramid images 521, 522, 523, 524 by inputting the high-definition input image 52 into the object detection model.

The object detection device then performs an EXPAND operation on the first low-resolution pyramid image 511, which is the highest resolution (top layer) of the plurality of low-resolution pyramid images. The object detection device then performs an elementwise addition operation on the second low-resolution pyramid image 512, which is the second highest resolution of the plurality of low-resolution pyramid images, and the first low-resolution pyramid image to generate the first low-resolution important object image 531.

The object detection device then performs an EXPAND operation on the first low-resolution important object image 531. The object detection device then performs an elementwise addition operation on the first low-resolution important object image and the third low-resolution pyramid image 513, which is the third highest resolution of the plurality of low-resolution pyramid images, to generate a second low-resolution important object image 532.

The object detection device then performs an EXPAND operation on the second low-resolution important object image 531. The object detection device then performs an elementwise addition operation on the fourth low-resolution pyramid image 514, which is the fourth highest resolution (lowest resolution) of the plurality of low-resolution pyramid images, and the second low-resolution important object image to generate the third low-resolution important object image 533.

The object detection device then performs a scaling operation on the third low-resolution important object image 533 to generate the first final important object image 591.

The object detection device then performs a scaling operation and a dilation-erosion operation on the first final important object image 591 to generate the first peripheral area image 541. The object detection device then performs an element-wise multiplication operation on the second high-resolution pyramid image 522, which is the second highest resolution of the plurality of previously generated high-resolution pyramid images, and the first perimeter image 541 to generate a first high-resolution important object image 551. The object detection device then performs an expansion operation on the first final important object image 591 and an elementwise addition operation on the first final important object image 591 and the first high-resolution important object image to generate a second final important object image 592.

The object detection device then performs a scaling operation and a dilation-erosion operation on the second final important object image 592 to generate the second peripheral area image 542. The object detection device then performs an element-wise multiplication operation on the third high-resolution pyramid image 523, which is the third highest resolution of the plurality of previously generated high-resolution pyramid images, and the second surrounding area image 542 to generate a second high-resolution important object image 552. The object detection device then performs an expansion operation on the second final important object image 592, and performs an elementwise addition operation on the second final important object image 592 and the second high-resolution important object image to generate a third final important object image 593.

The object detection device then performs a scaling operation and a dilation-erosion operation on the third final important object image 593 to generate the third peripheral area image 543. The object detection device then performs an element-wise multiplication operation on the fourth high-resolution pyramid image 524 and the third perimeter image 543, which is the fourth highest resolution of the plurality of previously generated high-resolution pyramid images, to generate a third high-resolution important object image 553. The object detection device then performs an expansion operation on the third final important object image 593, and performs an elementwise addition operation on the third final important object image 593 and the third high-resolution important object image to finally generate a fourth final important object image 594.

The object detection device then outputs the generated fourth and final important object image 594 via an output device.

In summary, the object detection device uses the input image to generate low-resolution/high-resolution input images 51, 52, generate low-resolution/high-resolution pyramid images 511, 512, 513, 514, 521, 522, 523, 524, generate low-resolution/high-resolution important object images 531, 532, 533, 551, 552, 563, and composite the low-resolution/high-resolution important object images with each other, generate low-resolution/high-resolution important object images 531, 532, 533, 551, 552, 553, and composite the low-resolution/high-resolution important object images with each other to generate final important object images 591, 592, 593, 594.

In synthesizing pyramid images of different resolutions (heterogeneous resolution), the object detection device can easily restore information lost during pyramid image generation by using the size of the first important object image 591 initially generated based on the lower resolution input image restored to the size of the input image for synthesis.

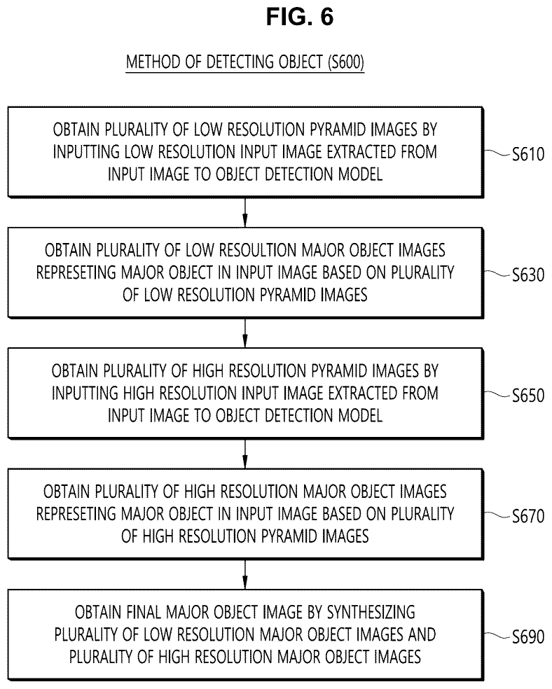

FIG. 6 is a flow diagram illustrating an object detection method according to one or more aspects of the present disclosure.

As shown in FIG. 6, an object detection method S600 of an object detection device includes steps S610, S630, S650, S670, and S690, which are described in more detail below.

First, an object detection device (object detection device 1 of FIG. 1 or object detection device 500 of FIG. 5) receives an input image, extracts a low-resolution input image from the input image, and inputs the low-resolution input image into an object detection model to obtain a plurality of low-resolution pyramid images (S610).

Next, based on the plurality of low-resolution pyramid images, the object detection model obtains a plurality of low-resolution important object images representative of important objects in the input image (S630).

The object detection device then extracts a high-resolution (original resolution) input image from the received input image, and inputs the high-resolution input image into an object detection model to obtain a plurality of high-resolution pyramid images (S650).

Then, based on the plurality of high-resolution pyramid images, the object detection model obtains a plurality of high-resolution important object images representative of important objects in the input image (S670).

The object detection device then synthesizes the plurality of high-resolution important object images and the plurality of low-resolution important object images to obtain a final important object image (S670).

The methods according to one or more aspects of the present disclosure may be implemented in the form of program instructions that may be executed through various computer means and recorded on a computer-readable medium. The computer-readable medium may include program instructions, data files, data structures, and the like, singly or in combination. The program instructions recorded on the computer-readable medium may be specifically designed and constructed for the present invention or may be known and available to those skilled in the art of computer software.

Examples of computer-readable media can include hardware devices that are specifically configured to store and execute program instructions, such as ROM, RAM, flash memory, and the like. Examples of program instructions may include machine language code, such as that created by a compiler, as well as high-level language code that may be executed by a computer using an interpreter or the like. The hardware devices described above may be configured to operate as at least one software module to perform the operations of the present invention, and vice versa.

Furthermore, the method or device described above may be implemented with all or part of its components or functions combined, or separately. The foregoing description of the invention is for illustrative purposes only, and those having ordinary knowledge in the technical field to which the invention belongs will understand that it can be readily adapted to other specific forms without altering the technical idea or essential features of the invention. The embodiments described above are therefore exemplary in all respects and should be construed as limiting knowledge. For example, each component described in a single form may be implemented in a distributed manner, and similarly, components described as distributed may be implemented in a combined form.

While the above has been described with reference to preferred embodiments of the present invention, it will be understood by those skilled in the art that various modifications and changes can be made to the present invention without departing from the spirit and scope of the invention as recited in the following patent claims.

What is claimed is:

1. An object detection device, comprising:
an input device for receiving an input image;
an object detection model for generating a plurality of input images of different resolutions using the input image, and obtaining a plurality of pyramid images of different resolutions using the input image;
a processor for obtaining an important object image representative of a predetermined important object in the input image based on the plurality of pyramid images; and
an output device for outputting the important object image.

2. The object detection device of claim 1, wherein the object detection model:
includes a backbone network including a plurality of layers for outputting a feature map from which semantic information is extracted from the input image;
is configured to generate a highest resolution pyramid image using a plurality of first feature maps having a smaller size among the plurality of feature maps output by the backbone network; and
is configured to generate a plurality of rest of pyramid images using a plurality of first feature maps having a smaller size among the plurality of feature maps output by the backbone network.

3. The object detection device of claim 2, wherein the object detection model:
is configured to generate a low resolution input image and a high resolution input image; and
is configured to obtain a plurality of low resolution pyramid images and a plurality of high resolution pyramid images using the low resolution input image and the high resolution input image.

4. The object detection device of claim 3, wherein the processor:
is configured to generate a plurality of low resolution important object images using the plurality of low resolution pyramid images;
is configured to generate a plurality of high resolution important object images using the plurality of high resolution pyramid images; and
is configured to obtain a final important object image by synthesizing the plurality of low resolution important object images and the plurality of high resolution important object images.

5. The object detection device of claim 4, wherein the processor:
is configured to generate a plurality of surrounding area images representative of regions surrounding the important object in the input image using the plurality of low resolution important object images and the plurality of high resolution important object images; and
is configured to generate the final important object image using the plurality of surrounding area images, the plurality of low resolution important object images and the plurality of high resolution important object images.

6. A method for detecting an important object from an input image by an object detection device, the method comprising:
generating, by an object detection model of the object detection device, a plurality of input images of different resolutions using the input image;
obtaining, by the object detection model, a plurality of pyramid images of different resolutions using the input image;
obtaining, by a processor of the object detection device, based on the plurality of pyramid images, an important object image representative of a predetermined important object in the input image; and
outputting, by an output device of the object detection device, an image of the important object.

7. The method of claim 6,
wherein the object detection model includes a backbone network including a plurality of layers outputting a feature map from which semantic information is extracted from the input image, and
wherein the method further comprises:
generating, by the object detection device, a highest resolution pyramid image using a plurality of first feature maps having a smaller size among the plurality of feature maps output by the backbone network; and
generating, by the object detection device, a plurality of rest of pyramid images using a plurality of first feature maps having a smaller size among the plurality of feature maps output by the backbone network.

8. The method of claim 7, further comprising:
generating, by the object detection model, a low resolution input image and a high resolution input image; and
obtaining, by the object detection model, a plurality of low resolution pyramid images and a plurality of high resolution pyramid images using the low resolution input image and the high resolution input image.

9. The method of claim 8, further comprising:
generating, by the processor, a plurality of low resolution important object images using the plurality of low resolution pyramid images;
generating, by the processor, a plurality of high resolution important object images using the plurality of high resolution pyramid images; and
obtaining, by the processor, a final important object image by synthesizing the plurality of low resolution important object images and the plurality of high resolution important object images.

10. The method of claim 9, further comprising:
generating, by the processor, a plurality of surrounding area images representative of regions surrounding the important object in the input image using the plurality of low resolution important object images and the plurality of high resolution important object images; and
generating, by the processor, the final important object image using the plurality of surrounding area images, the plurality of low resolution important object images and the plurality of high resolution important object images.
